(19) United States
(12) Patent Application Publication
(10) Pub. No.: US 2005/0122469 A1
(43) Pub. Date: Jun. 9, 2005

(54) Integration of semiconductor components in eyeglasses

(76) Inventor: Christoph Brabec, Erlangen (DE)

Correspondence Address: YOUNG & THOMPSON, 745 SOUTH 23RD STREET, 2ND FLOOR, ARLINGTON, VA, 22202, US

(21) Appl. No.: 10/504,091

(22) PCT Filed: Feb. 10, 2003
(86) PCT No.: PCT/DE03/00385

(30) Foreign Application Priority Data
Feb. 11, 2002 (DE) 102 05 579.3

(51) Int. Cl. G02C 1/00

(52) U.S. Cl. 351/158

(57) ABSTRACT

The invention relates to the integration of semiconductor components, particularly (organic) solar cells and/or power converters, in eyeglasses.

The invention relates to the integration of semiconductor components, particularly (organic) solar cells in eyeglasses.

The development of organic photoelectronics, in other words of photoelectronics wholly or partially constructed from organic polymers has made it possible to develop these in a particularly small, thin and flexible form. This results in a multiplicity of possible uses which were not previously possible or were even previously unknown.

The present invention relates in this context to an eyeglass with integrated energy converter based on at least one semiconductor component.

Since eyeglasses, in particular spectacles, are worn almost constantly by their user, they are an ideal object for providing ‘invisible’ energy supply, as is made available with the present invention. The energy supply is thus guaranteed by means of a semiconductor component, regardless of whether or not it is coupled to a battery or capacitor. Adequate power is guaranteed for the widest variety of connections, especially if the semiconductor component comprises solar cells, since these convert sunlight directly into electrical energy.

The solar cell is preferably semitransparent, since then its integration in the eyeglass does not disturb the wearer and/or alter the aesthetic impression of the eyeglass in any way.

The semitransparent solar cell can be integrated into the glasses frame or parts thereof. It is however preferable for this solar cell or solar cells to be automatically integrated into the eyeglass glass or parts thereof, since this guarantees an improved insolation. The solar cell or the semiconductor component which can also be connected in accordance with the invention as a photodetector is particularly preferably constructed completely from organic semiconductors and in particular, conjugated polymers, since these are already originally transparent and enable a particularly thin layered, small and flexible embodiment of the photoelectronic component. The invention is not limited to the use of polymer organic semiconductors, but can also include the use of other organic or special semiconductors, in particular those referred to as “small molecules”.

The transparency of the solar cell and/or the photodetector and thus also the eyeglass glass is adjusted to the performance specifications, depending on the desired performance and function.

In accordance with the invention, the energy converter integrated in this way is designed to be used as an energy supply for any device, in the form of a solar cell and/or a photodetector. The energy converter thus also serves as the energy supply for transponders, hearing aids, cameras and such like. A semitransparent solar cell which is integrated into the eyeglass glass can control a darkening system which is similarly integrated into the eyeglass, for example on the basis of switchable polarization filters made from liquid crystalline plastics or based on electrochrome effects. The exposure measurement which regulates the degree of the darkening of the eyeglass can be implemented similarly through the solar cells, when it is used as a photodetector. By combining the measuring and regulating functions of the illumination strength, an eyeglass glass is effected which is adjusted quickly and flexibly to the particular light conditions. An eyeglass with an integrated photodetector range can also be used for image detection.

It is clear for a person skilled in the appropriate art that there are many areas of application areas and that the aforementioned enumeration can not be considered as definitive. A semiconductor in the form of a solar cell or photodetectors of other types, which a user possibly carries permanently on or with him, can be integrated and serve as a power supply.

1-9. (canceled)

10. Eyeglass with an integrated energy converter based on at least one semiconductor component.

11. Eyeglass according to claim 10, wherein
the at least one semiconductor is a solar cell.

12. Eyeglass according to claim 11, wherein
the solar cell is semitransparent.

13. Eyeglass according to claim 12, wherein
the solar cell is integrated into the eyeglass glass or parts thereof.

14. Eyeglass according to claim 12, wherein
the solar sell is integrated into the glasses frame or parts thereof.

15. Eyeglass according to claim 10, wherein
the solar cell is constructed from organic polymers.

16. Eyeglass according to claim 10, wherein
the solar cell is connected as a photodetector.

17. Eyeglass according to claim 10, wherein
the energy converter can be used as the energy supply for any devices.

18. Eyeglass according to claim 16, wherein
the solar cell controls a darkening system also integrated into the eyeglass.
